(19) United States
(12) Patent Application Publication
(10) Pub. No.: US 2015/0317909 A1
(43) Pub. Date: Nov. 5, 2015

(54) APPARATUS AND METHOD OF SIMULATING A THERMOMETER

(71) Applicants: Peter Florkoski, Windsor, CT (US); Michael Curtis Foss, Springfield, MA (US); Christopher Scott, Feeding Hills, MA (US); Jeffrey M. Witek, Wilbraham, MA (US)

(72) Inventors: Peter Florkoski, Windsor, CT (US); Michael Curtis Foss, Springfield, MA (US); Christopher Scott, Feeding Hills, MA (US); Jeffrey M. Witek, Wilbraham, MA (US)

(21) Appl. No.: 14/698,953

(22) Filed: Apr. 29, 2015

Related U.S. Application Data
(60) Provisional application No. 61/986,412, filed on Apr. 30, 2014.

(51) Int. Cl. G09B 9/00; G09B 5/00; G09B 23/30

(52) U.S. Cl. CPC G09B 9/00; G09B 23/30; G09B 5/00

(57) ABSTRACT

A device for training medical personnel to measure a simulated patient's temperature is provided. The device includes at least one sensor configured to measure an attribute of the device's motion. A display and a wireless communications device are provided. A controller is electrically coupled to the at least one sensor, the display and the wireless communications device, the controller having a processor that is responsive to executable computer instructions to display a value on the display in response to the at least one sensor measuring the attribute.

### BACKGROUND OF THE INVENTION

The subject matter disclosed herein relates to a training device for medical personnel and, in particular, to a simulated thermometer for using during a medical training simulation.

A manikin is a life-sized anatomical human model used as a teaching aid in medical education for training doctors, nurses, paramedics as well as other learners in, for example, emergency care and resuscitation of humans. A number of companies produce manikins. Generally manikins are three-dimensional models of all or part of a human being and are intended to be as realistic as possible in order to provide the learners with a realistic situation. The manikin can be used to instruct learners using a so-called “training scenario.” The training scenarios are designed to be realistic simulations of medical emergencies that might occur in real-life. An instructor can institute one or more of the training scenarios and view how the learner responds to the implemented training scenario.

Medical devices used in medical training typically are matched with a particular manikin that cooperates with the device to provide the simulation training. Unfortunately, this creates logistical issues for the medical training facility as the appropriate equipment needs to be associated with the proper manikin. As equipment becomes worn, or needs to be repaired, sections of the training facility may become unusable in the training.

Accordingly, while existing medical training devices are suitable for their intended purposes the need for improvement remains, particularly in providing a simulated medical thermometer device that may be used in any training scenario.

### BRIEF DESCRIPTION OF THE INVENTION

According to one aspect of the invention, a device for training medical personnel to measure a simulated patient's temperature is provided. The device including at least one sensor that is configured to measure an attribute of the device's motion. A display and a communications device are further provided. A controller is electrically coupled to the at least one sensor, the display and the communications device. The controller includes a processor that is responsive to executable computer instructions to display a value on the display in response to the at least one sensor measuring the attribute.

According to another aspect of the invention, a method of training medical personnel using a simulated patient is provided. The method comprises: providing a thermometer device having at least one sensor for monitoring an attribute of the thermometer device's motion, the thermometer device further having a display and a wireless communication device; placing the thermometer device against a surface of the simulated patient; determining a first value with the sensor; receiving a first signal with the wireless communication device; displaying a second value on the display.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a thermometer training device according to an embodiment of the invention;

FIG. 2 is a perspective view illustration of a thermometer training device of FIG. 1 in accordance with an embodiment of the invention;

FIG. 3 is a perspective view illustration of the thermometer training device of FIG. 1 in accordance with another embodiment of the invention;

FIG. 4 is an illustration of the thermometer training device of FIG. 1 being used on a simulated patient;

FIG. 5 is an illustration of the thermometer training device and simulated patient of FIG. 1 with the thermometer training device in a third position;

FIG. 6 is a graphical plot of force sensor data over time in accordance with an embodiment of the invention; and

FIG. 7 is a graphical plot of accelerometer data over time in accordance with an embodiment of the invention.

The detailed description explains embodiments of the invention, together with advantages and features, by way of example with reference to the drawings.

### DETAILED DESCRIPTION OF THE INVENTION

Embodiments of the present invention provide advantages in allowing medical personnel to be trained on the use of a temporal thermometer on a simulated patient or manikin. Embodiments of the present invention provide advantages in determining when the motion of a temporal thermometer training device is within a desired range. Embodiments of the present invention provide for wireless communication with a remote device that allows the trainer or teacher to change the simulation parameters in real-time. Still further embodiments of the invention allow for the transmission of data acquired by the temporal thermometer training device during a training session to a remote device.

For purposes herein, the term simulated patient may include an artificial body, such as a manikin for example, that imitates a patient, or it may be a living person scenario (e.g. another student) acting as a patient for purposes of a training.

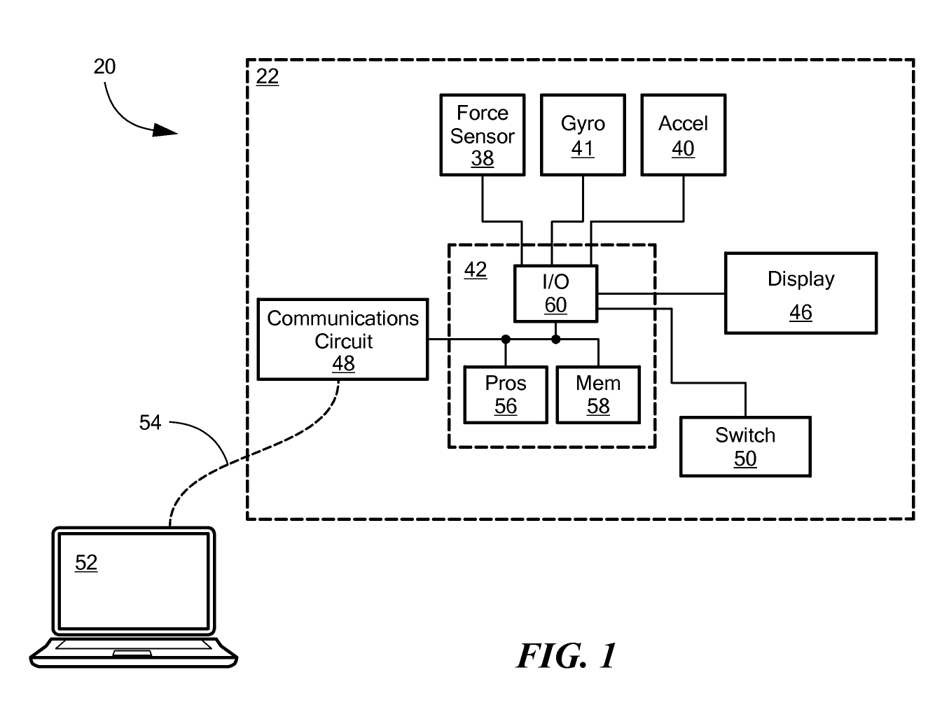

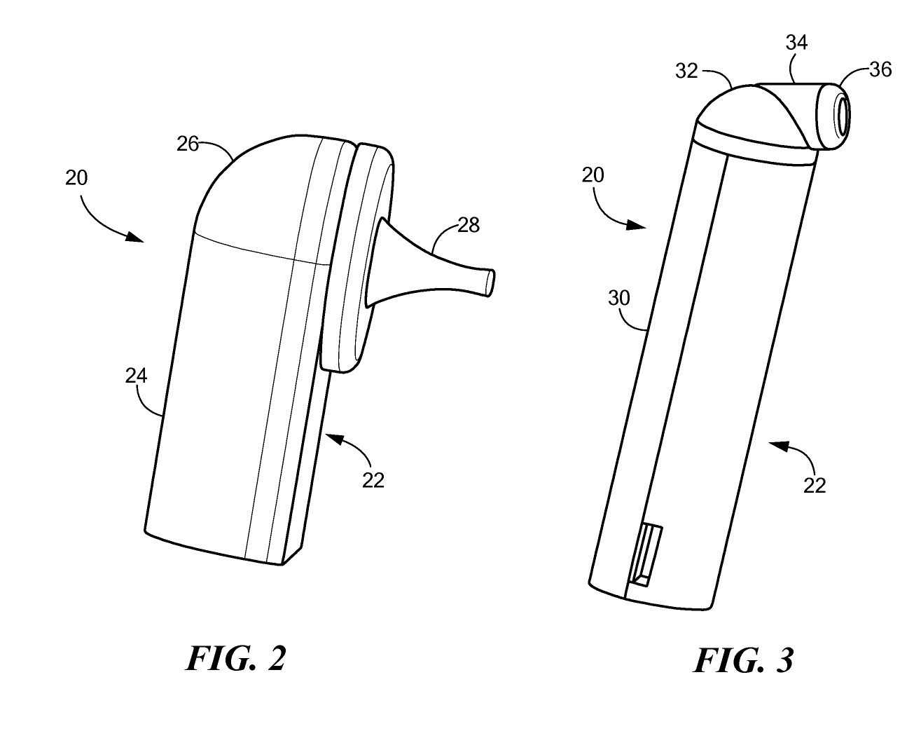

Referring now to FIG. 1, a thermometer training device 20 is shown. The thermometer training device 20 includes a housing 22 that is in the shape and size of an actual functioning thermometer that would be used by medical personnel in treating patients. In one embodiment, shown in FIG. 2, the housing 22 has an elongated body portion 24 with a semi-spherical end 26 that terminates in a tip 28. As will be discussed in more detail below, the tip 28 cooperates with a force sensor that generates a signal in response to the tip being used on a simulated patient. In one embodiment, the tip 28 is used to simulate a temporal thermometer. In another embodiment, the tip 28 is frusto-conical or a hyperboloid shape and sized to fit within a patients ear to simulate an infrared ear thermometer. In another embodiment, shown in FIG. 3, the housing 22 has a cylindrical elongated body portion 30 with a semi-spherical end 32. A generally cylindrical projection 34 extends from the semi-spherical end 32. A simulated temporal temperature sensor 36 is disposed on the end of the cylindrical projection 34.

Arranged within the housing 22 is a force sensor 38 arranged adjacent the tip 28 or the simulated sensor 36. The force sensor 38 detects a load attribute when a force is applied to the tip 28 or simulated sensor 36 and a signal is generated in response. The force sensor 38 may be, but is not limited to, a strain gauge load cell or a piezoelectric transducer for example. In some embodiments, the thermometer training device 20 may also include one or more motion detectors, such as a multi-axis accelerometer 40 and a gyroscope 41 for example. The accelerometer measures a motion attribute and generates a signal in response to motion of the housing 22 by the operator. The gyroscope 41 measures motion attributes to determine the rotation or orientation of the thermometer training device. It should be appreciated that while embodiments herein may refer to the motion detector as a discrete multi-axis accelerometer and gyroscope, this is for exemplary purposes and the claimed invention should not be so limited. In one embodiment, the motion detector is an integrated microelectromechanical system that includes both a three-axis accelerometer function and a three-axis gyroscope function. In other embodiments, the motion detector may be, but is not limited to, a gyroscope, a quartz rate sensor, a magnetohydrodynamic (MDH) senor, a microelectromechanical system (MEMS) gyroscope, a laser gyroscope, or a timing and inertial measurement unit (TIMU) sensor for example.

The signals transmitted by the force sensor 38 and accelerometer 40 are transmitted to a controller 42. The controller 42 is a suitable electronic device capable of accepting data and instructions, executing the instructions to process the data, and presenting the results. Controller 42 may accept instructions through user interface, or through other means such as but not limited to electronic data card, voice activation means, manually-operable selection and control means, radiated wavelength and electronic or electrical transfer.

Controller 42 is capable of converting the analog voltage or current level provided by force sensor 38 and accelerometer 40 into a digital signal indicative of the level of force applied to the tip/sensor 28, 36. In some embodiments, one or either of the force sensor 38 and accelerometer 40 may be configured to provide a digital signal to controller 42, or an analog-to-digital (A/D) converter (not shown) may be provided to convert the analog signal into a digital signal for processing by controller 42. Controller 42 uses the digital signals act as input to various processes for controlling the thermometer training device 20.

Controller 42 is operably coupled with one or more components of thermometer training device 20 by data transmission media 44. Data transmission media 44 includes, but is not limited to, twisted pair wiring, coaxial cable, and fiber optic cable. Data transmission media 44 also includes, but is not limited to, wireless, radio and infrared signal transmission systems. The data transmission media 44 may support Bluetooth or Wifi compatible transmissions. Controller 42 is configured to provide operating signals to these components and to receive data from these components via data transmission media 44.

In general, controller 42 accepts data from force sensor 38 and accelerometer 40 and is given certain instructions for the purpose of comparing the data from force sensor 38 and accelerometer 40 to predetermined operational parameters. Controller 42 may provide operating signals to a display 46 and communications device 48. Controller 42 may also accepts signals from a switch 50, indicating, for example, whether the operator is using the thermometer training device 20. As will be discussed in more detail below, the controller 42 compares the operational parameters to predetermined variances (e.g. pressure applied to simulated patient, rate at which the thermometer training device 20 is moved between positions) and if the predetermined variance is exceeded, generates a signal that may be transmitted via the communications device 48 to a remote system 52 and indicate to a trainer, for example, whether the operator is properly operating the thermometer training device. Additionally, the signal may initiate other control methods that adapt the operation of the thermometer training device such as changing the temperature displayed on the display 46. For example, if controller 42 determines that the operator has moved the thermometer training device 20 too rapidly to accurately determine a temperature, the controller 42 may transmit a signal to display an erroneous value on the display 46.

The display 46 may be an LED (light-emitting diode) display, an LCD (liquid-crystal diode) display, a CRT (cathode ray tube) display, a organic light-emitting diode (OLED), or the like. A keypad (not shown) may also be provided for transmitting data input to controller 42.

The communications circuit 48 allows the controller 42 to be coupled to external computer networks such as a local area network (LAN) 54 and the Internet. LAN 54 interconnects one or more remote computers 52, which are configured to communicate with controller 42 using a well-known computer communications protocol such as TCP/IP (Transmission Control Protocol/Internet(̂) Protocol), RS-232, ModBus, and the like.

Controller 42 includes a processor 56 coupled to memory 58. The memory 58 may include one or more of random access memory (RAM), a non-volatile memory (NVM) and read-only memory (ROM). One or more input/output (I/O) controllers 60 may be incorporated to adapt signals transmitted to and from the controller 42.

Memory device 58 stores an application code, e.g., main functionality firmware, including initializing parameters, and boot code, for processor 56. Application code also includes program instructions for causing processor 56 to execute any operation control methods, including starting and stopping operation, and displaying a temperature. The information to be exchanged remote computers 52 and the controller 56 include but are not limited to temperatures to be displayed, temperatures actually displayed, force applied, rate or acceleration of movement of the thermometer training device 20.

It should be appreciated that modern thermometers, such as infrared ear thermometers or temporal thermometers, need to be used properly in order to determine and record an accurate patient temperature. For example, an infrared ear thermometer needs to be inserted into the patient's ear with sufficient force to penetrate the ear and make the eardrum visible to the infrared sensor without using excess force that causes discomfort to the patient. Similarly, temporal thermometers need to be moved across the patient's forehead and to a location behind the ear at a desired speed while applying a desired amount of force. If the thermometer is not used as intended, erroneous temperature readings may result.

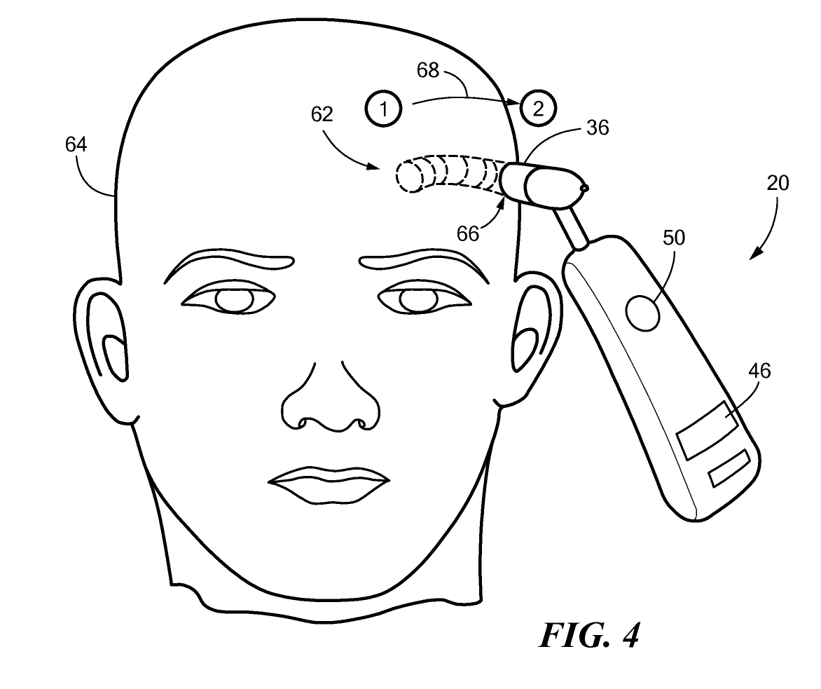

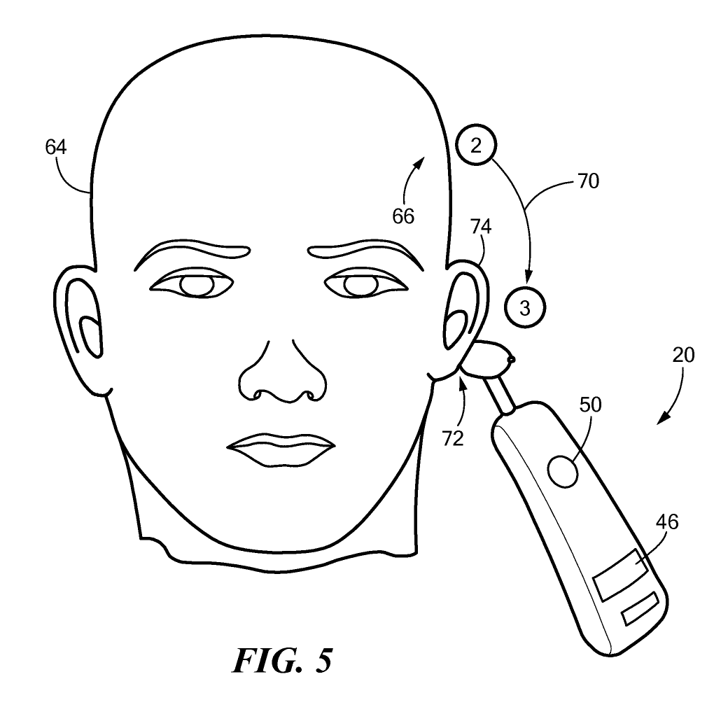

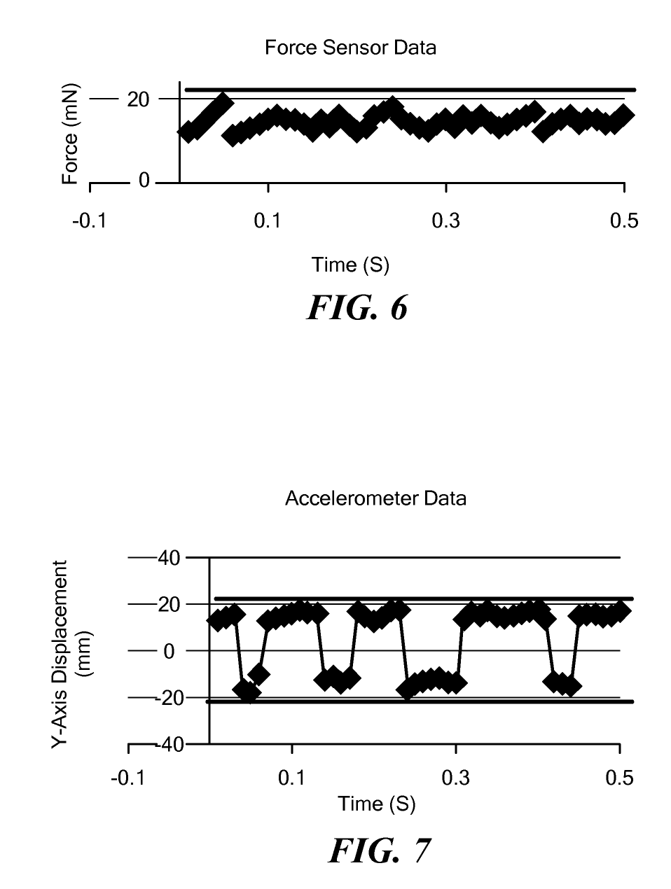

Referring now to FIGS. 4-7, the thermometer training device 20 that simulates a temporal thermometer is shown during two stages of operation. First, the operator places the simulated sensor 36 against the forehead area 62 of a simulated patient 64. The operator then moves the thermometer training device 20 across the simulated patient's head to a second position 66 as indicated by the arrow 68. As the thermometer training device 20 is moved, the force sensor 38 and accelerometer 40 generate signals that are transferred to the controller 42. FIGS. 6-7 show exemplary plots of force and acceleration data acquired during testing. It should be appreciated that if the operator fails to apply sufficient force or moves the thermometer training device too rapidly, that an inaccurate temperature reading may result.

After reaching the second position 66, the operator then moves the thermometer training device 20 in the direction indicated by the arrow 70 to a third position 72. In the exemplary embodiment, the third position is behind the ear 74 of the simulated patient 64. As the operator moves the thermometer training device 20 from the second position 66 to the third position 72, the controller 42 monitors the signals from the force sensor 38 and accelerometer 40 to determine the force and rate at which the operator moves the thermometer training device 20.

It should be appreciated that in instances where force or rate of movement falls below or exceeds predetermined threshold for achieving accurate temperature readings, that the controller 42 may perform different operational methods depending on the environment or application in which the thermometer training device 20 is being used. In one embodiment, the controller 42 may provide feedback to the operator via the display 46 as the temperature measurement is being performed when the predetermined thresholds for force and rate of movement cross a threshold. For example, the display 46 may be illuminated in different colors or an icon may be displayed in response to or while using the device. This provides advantages in training applications where the operator is learning how to use a thermometer. In another embodiment, the controller 42 displays an inaccurate temperature on the display 46 in response to one or more of the predetermined thresholds being crossed. This provides advantages in a simulated medical environment to show the operator the consequences of performing the steps incorrectly. In still another embodiment, the temperature displayed on the display 46 may be user definable by a trainer or teacher on the remote computer 52. This allows the trainer to change the simulation to achieve a desired situation.

Embodiments of the present invention provide advantages in allowing the training of medical personnel in the use of thermometers to achieve desired accuracy. Embodiments of the invention provide advantages in providing a general thermometer training device that may be used with any simulated patient or even a real human-being during training. Still further embodiments of the invention provide advantages in allowing the simulation parameters to be changed remotely to create a desired medical situation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A device for training medical personnel to measure a simulated patient's temperature, the device comprising:
at least one sensor configured to measure an attribute of the device's motion;
a display;
a communications device; and
a controller electrically coupled to the at least one sensor, the display and the communications device, the controller having a processor that is responsive to executable computer instructions to display a simulated patient temperature value on the display in response to the at least one sensor measuring the attribute.

2. The device of claim 1 wherein the at least one sensor is a force sensor configured to contact a surface of the simulated patient.

3. The device of claim 2 further comprising a motion sensor electrically coupled to the controller, the motion sensor configured to measure the acceleration of the device during operation.

4. The device of claim 3 wherein the processor is further responsive to receiving a first signal from the communications device and determining the simulated patient temperature value base at least in part on the first signal.

5. The device of claim 3 wherein the processor is further responsive to transmitting a second signal to the communications device in response to receiving a third signal from at least one of the force sensor and the motion sensor.

6. The device of claim 5 wherein the processor is further responsive to determining the simulated patient temperature value based at least in part on the third signal.

7. The device of claim 2 further comprising a tip portion adjacent the force sensor.

8. The device of claim 7 wherein the tip portion has a semi-spherical end.

9. The device of claim 7 wherein the tip portion has a frusto-conical shape.

10. The device of claim 7 wherein the top portion has a hyperboloid shape.

11. A method of training medical personnel using a simulated patient, the method comprising:
providing a thermometer device having at least one sensor for monitoring an attribute of the thermometer device's motion, the thermometer device further having a display and a wireless communication device;
placing the thermometer device against a surface of the simulated patient;
determining a first value with the sensor;
receiving a first signal with the wireless communication device;
displaying a second value on the display.

12. The method of claim 11 wherein the at least one sensor is a force sensor and the first value is a level of force that the thermometer device is pressed against the simulated patient.

13. The method of claim 12 further comprising:
providing an accelerometer sensor in the thermometer device; and
measuring the acceleration of the thermometer device in response to moving the thermometer device from a first position to a second position.

14. The method of claim 13 further comprising determining the second value in response to receiving the first signal.

15. The method of claim 13 further comprising determining the second value based at least in part on the first signal and the first value.

16. The method of claim 15 further comprising determining the second value based at least in part on the first signal, the first value, and the acceleration measured by the accelerometer.

17. The method of claim 13 further comprising transmitting a second signal to a remote device via the wireless communications device.

18. The method of claim 17 wherein the second signal includes at least one of force data or acceleration data.

19. The method of claim 11 wherein the thermometer device includes a tip portion, and the step of placing the thermometer device against the surface of the simulated patient includes inserting the top into the simulated patients ear.

20. The method of claim 13 wherein the step of moving the device from the first position to the second position includes moving the thermometer device across the simulated patients forehead.
